(19) United States
(12) Patent Application Publication
(10) Pub. No.: US 2003/0140273 A1
(43) Pub. Date: Jul. 24, 2003

(54) Method and apparatus for fault tolerant persistency service on network device

(76) Inventors: Ajay Kamalvanshi, San Jose, CA (US); Madhu Grandhi, Fremont, CA (US)

Correspondence Address: MATHEWS, COLLINS, SHEPHERD & MCKAY, P.A., 100 THANET CIRCLE, SUITE 306, PRINCETON, NJ, 08540-3674, US

(21) Appl. No.: 10/027,577

(22) Filed: Dec. 20, 2001

(51) Int. Cl. H02H 3/05

(52) U.S. Cl. 714/13

(57) ABSTRACT

A method for providing persistency fault tolerant data stored in a database on a device in a networked environment for an external application, the device having an active processor system and a standby processor system involves the following steps: providing an identical standby copy of an active database located on the active processor system, on the standby processor system; monitoring the active processor for a failure; and assuming control by the standby processor assumes control when the failure is detected; wherein switching from the active database to the standby database is transparent to the external application.

### FIELD OF THE INVENTION

This invention relates to communication networks and more particularly to data storage for an optical communication network.

### BACKGROUND OF THE INVENTION

While Internet Protocol (“IP”) traffic will represent more than 90 percent of the total public communication network traffic by 2002 and communication service providers plan to invest more than $70 billion in core routing and optical transmission equipment to significantly expand their IP/optical backbone networks, revenues from IP services will only approach $25 billion, which represents only a third of the total communication network services revenue pool of $75 billion. This revenue dilemma is primarily the result of extensive competition in the Internet access market, which has essentially resulted in commodity, flat rate pricing. Extensive use of graphics, audio and video content has driven average utilization up significantly, yet the user is charged the same rate. Service providers must add capacity in the network core without any corresponding increase in revenue. The real challenge for service providers is how to generate more revenue from their IP/optical backbones. By taking advantage of the latest advances in IP quality of service (“QoS”), multiprotocol label switching (“MPLS”), and service transformation technology (the conversion of non-IP services to IP), service providers can evolve dedicated IP infrastructures into a multi-service network architecture, as an alternative to operating separate service-specific networks. The new network architecture is a single multi-service network using IP as the underlying protocol for all service delivery. This allows service providers to supplement IP revenues with other established network service revenues from frame relay, TDM private lines and ATM, resulting in faster payback of the tremendous carrier investment in their IP/optical networks.

However, all facets of the multi-service network architecture must have the reliability of the networks it intends to supplement or replace. Fault tolerance must start at the network edge where services converge. While traditional databases provide efficient storage, they do not address the problems and issues of providing high reliability fault tolerant systems necessary for network devices in this environment. Therefore there is a need for high reliability fault tolerant database storage in the multi-service network environment.

### SUMMARY OF THE INVENTION

In one aspect, the present invention provides a method for providing persistency fault tolerant data stored in a database on a device in a networked environment for an external application, the device having an active processor system and a standby processor system. The method comprises the following steps: providing an identical standby copy of an active database located on the active processor system, on the standby processor system; monitoring the active processor for a failure; and assuming control by the standby processor assumes control when the failure is detected; wherein switching from the active database to the standby database is transparent to the external application. A system is also disclosed.

### BRIEF DESCRIPTION OF THE DRAWINGS

A more complete understanding of the present invention may be obtained from consideration of the following description in conjunction with the drawings in which:

FIG. 1 is a high-level functional block diagram of the relationship of system elements; and,

FIG. 2 is a high-level functional block diagram showing the interaction between a representative external application and the datastore module.

### DETAILED DESCRIPTION OF VARIOUS ILLUSTRATIVE EMBODIMENTS

While the present invention is particularly well suited for use with the AmberNetwork ASR2000 and ASR2020 router devices and shall be so described herein, it is equally suited for use with other optical routers having similar capabilities and features for implementation of MPLS redundancy. MPLS (Multiprotocol Label Switching) is a standards-approved technology for speeding up network traffic flow and making it easier to manage. MPLS involves setting up a specific path for a given sequence of packets, identified by a label put in each packet, thus saving the time needed for a router to look up the address to the next node to forward the packet to. MPLS is called multiprotocol because it works with the Internet Protocol (“IP”), Asynchronous Transport Mode (“ATM”), and various frame relay network protocols. Referring to the standard Open Systems Interconnection (“OSI”), MPLS allows most packets to be forwarded at the layer 2 (switching) level rather than at the layer 3 (routing) level. In addition to moving traffic faster overall, MPLS makes it easy to manage a network for quality of service (“QoS”). For these reasons, the technique is expected to be readily adopted as networks begin to carry more and different mixtures of traffic.

While MPLS was originally a way of improving the forwarding speed of routers it is emerging as a crucial standard technology that offers new capabilities for large-scale IP networks. Traffic engineering, the ability of network operators to dictate the path that traffic takes through their network, and Virtual Private Network support are examples of two key applications where MPLS is superior to any currently available IP technology.

MPLS LDP, CR-LDP, RSVP, RSVP-TE and other protocols are defined by the Internet Engineering Task Force (“IETF”). The definitions describe the need for protocol redundancy; however do not provide information on its implementation, which is essentially left to a vendor/manufacturer to implement for their particular application requirements. An edge router is a device that routes data between one or more local area networks (LANs) and a backbone network. An edge router is an example of an edge device and is sometimes referred to as a boundary router. An edge router is sometimes contrasted with a core router, which forwards packets to computer hosts within a network (but not between networks).

With an aggregation and core router application, failure of a protocol, can lead to an unacceptable network down time. Hardware and software redundancy must be provided to provide high network availability. While traditional databases provide efficient storage, they do not address the problems and issues of providing high reliability fault tolerant systems necessary for network devices in this environment. The present invention, Method and Apparatus for Fault Tolerant Service on Network Device, enables high reliability fault tolerant database storage in the multi-service network environment.

In one aspect, the present invention provides a system and method for providing persistency fault tolerant data in a networked environment for an external application. In brief, the method comprises defining a database using Structure of Management Information version 2 (SMIv2) format, then generating structure and metadata corresponding to the database using the SMIv2 definition. Providing an identical standby copy of the database located on a primary system, on a secondary system and accessing the active database through an application program interface. Switching from the active database to the standby database is done transparently (to the external application) when a fault is detected in the primary system.

The present invention provides an efficient persistency for a network data storage device that is fault tolerant. The present invention enables an application to define the data persistency requirements in SMIv2 (Structure of Management Information version 2) format and generate the required schema. The application interacts using APIs (Application Programming Interfaces) to read and/or write persistent information. This enables the application to be highly available as a copy of the data and the necessary library are redundantly kept in the other control plane. When a failure occurs, the redundant card takes over and the same data is available on the redundant control plane.

The present invention supports different kinds of conventional data, including opaque data. Copies of the database with its signature can be verified by the application without having to extract the data from the database.

From the perspective of a network manager, network management takes place between two major types of systems: those systems in control, called managing systems, and those systems observed and being controlled, called managed systems. The most common managing system is called a Network Management System (NMS). Managed systems can include hosts, servers, or network components such as routers or intelligent repeaters.

To promote interoperability, cooperating systems must adhere to a common framework and a common language, called a protocol. In the Internet Network Management Framework, that protocol is the Simple Network Management Protocol, commonly called SNMP.

The exchange of information between managed network devices and a robust NMS is essential for reliable performance of a managed network. Because some of these devices may have a limited ability to run management software, the software must minimize its performance impact on the managed device. The bulk of the computer processing burden, therefore, is assumed by the NMS. The NMS in turn runs the network management applications that present management information to network managers and other users.

In a managed device, the specialized low-impact software modules, called agents, access information about the managed devices and make it available to the NMS. Managed devices maintain values for a number of variables and report those, as required, to the NMS. For example, an agent might report such data as the number of bytes and packets in and out of the device, or the number of broadcast messages that were sent and received. In the Internet Network Management Framework, each of these variables is referred to as a managed object. A managed object is a classification of anything that can be managed, anything that an agent can access and report back to the NMS. All managed objects are contained in the Management Information Base (MIB), a database of the managed objects.

An NMS can control a managed device by sending a message to the agent (of that managed device) requiring the device to change the value of one or more of its variables. The managed devices can respond to commands such as Sets or Gets. Sets are used by the NMS to control the device. Gets are used by the NMS to monitor the device.

MIB variables are accessible via the Simple Network Management Protocol (SNMP), which is an application-layer protocol designed to facilitate the exchange of management information between network devices. The SNMP system consists of three parts: SNMP manager, SNMP agent, and MIB.

Instead of defining a large set of commands, SNMP places all operations in a get-request, get-next-request, get-bulk-request, and set-request format. For example, an SNMP manager can get a value from an SNMP agent or store a value in that SNMP agent. The SNMP manager can be part of a network management system (NMS), and the SNMP agent can reside on a networking device such as a router. The MIB is compiled with network management software. If an SNMP is configured on a router, the SNMP agent can respond to MIB-related queries being sent by the NMS.

An example of an NMS is the network management software which uses the MIB variables to set device variables and to poll devices on the inter-network for specific information. The results of a poll can be graphed and analyzed to help you troubleshoot inter-network problems, increase network performance, verify the configuration of devices, monitor traffic loads, and more.

The SNMP agent gathers data from the MIB, which is the repository for information about device parameters and network data. The agent also can send traps, or notifications of certain events, to the manager.

The present invention, Method And Apparatus For Fault Tolerant Service On Network Device, utilizes a database implemented using the IETF SMIv2 format as a collection of managed objects contained in a MIB, which is a database of managed objects. The program interacts using the API to read or write persistent information. The database uses the IETF SMIv2 format as a data definition language. SMIv2 Management information is viewed as a collection of managed objects, residing in a virtual information store, MIB (the Management Information Base). Collections of related objects are defined in MIB modules. These modules are written using an adapted subset of OSI's Abstract Syntax Notation One, ASN.1 (1988). Structure of Management Information (SMI), defines the adapted subset, and to assign a set of associated administrative values. The SMI is divided into three parts: module definitions, object definitions, and, notification definitions. The final RFCs (Request For Comments) defining SMIv2 have been published as Internet Standard 58 in April 1999: Structure of Management Information Version 2 (SMIv2), RFC 2578, STD 58, April 1999; Textual Conventions for SMIv2, RFC 2579, STD 58, April 1999; and, Conformance Statements for SMIv2, RFC 2580, STD 58, April 1999 and are herein incorporated by reference as if set out in full.

Conventional databases use complex mechanisms for storing data which are essentially not designed for use as a network device because of their lack of fault tolerance. The present invention provides for a new way for storing data which makes it fault tolerant. The application services that require persistency information define the layout schema of the database using SMIv2 format. Other databases either use a proprietary data definition language or a Structured Query Language (SQL) for defining their data. The present invention has data elements defined in SMIv2 format which is then used to generate structures and metadata. The generated structures are used by the application to read and write data. The metadata is used by a database service called datastore to provide access to the data.

When a network device is started for the first time the layout schema is initialized on top of the file system. The file system is expected to provide POSIX compliant file IO functions. The applications are notified to then initialize their records by returning an error message when the first read is done. The present invention supports dynamic records that can grow dynamically. The application can then read and write to the persistent information using the database record id (that is generated by the tool) and the row number. A checksum is maintained for each record and is checked every time the system reboots. An identical copy of the database is kept on standby. When the standby module is plugged in, provisioning on the active module is frozen and the database is copied from the active to the standby system. After the database copy is completed standby tasks are spawned. This enables all of the tasks to see the same database as each change in the active database is sent to the standby database as well.

A backup copy (snapshot) of the database is made using tar and compression techniques. This backup mechanism is similar to the standard application. In addition a magic number is kept to distinguish any tar and zipped file with the datastore snapshot. A version number is stored in the zipped file. The gzip's header's comment field is used to store both the magic number and the version information. All backup copies are also kept redundant.

The database is designed to provide a transparent version upgrade when it detects an older version. This is done by using the dsrevise tool to find the changes between the database versions and then generates the code for upgrading the older version to the newer version.

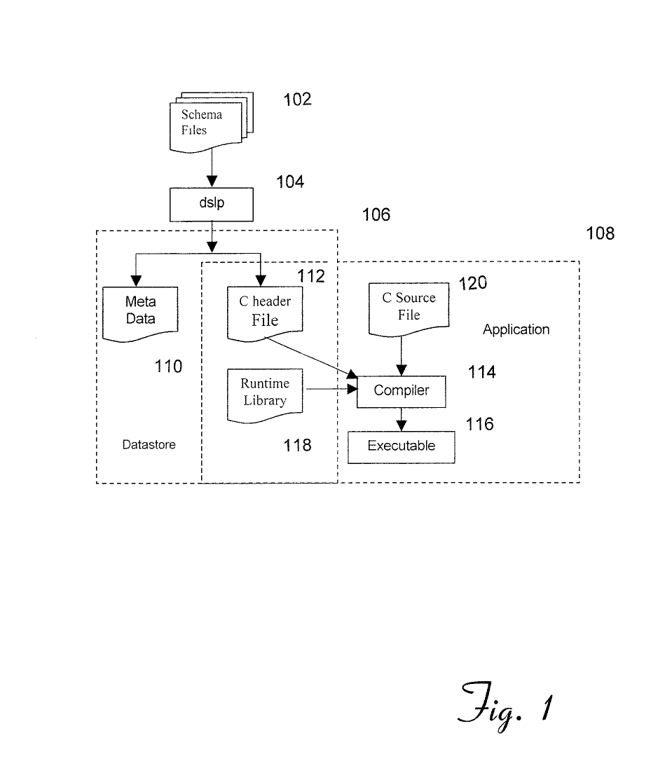

Referring to FIG. 1 there is shown the interaction between the definitions, datastore and application. The application defines the data definitions essentially by defining the MIB. These schema files 102 describes definition of items such as the host, temperature sensor, system card information and line card information that required being persistent in order for the system to be highly reliable and highly available. After the MIB is defined, the MIB definitions are then used to generate information that is used by the system. This is done using the datastore language processor utility (dslp) 104. This generates files used by datastore 106 and application 108. This includes meta data 110 and C header file 112. The application 108 utilizes a complier 114 to generate an executable module 116 from the runtime library 118 and the C source code file 120.

The dslp utility 104 then generates the following files.

dsRecId.h: contains the record identities. This contains the record identifies for all the records defined. These record identifiers are used the applications.

dsMeta.h: contains the record information required by datastore.

dsPrintDir.h: contains the mapping for print functions. This is used for ds₁₃ showRecords.

dsPrintProto.h: contains print prototypes for all the datastore records. The application developer can provide implementation of these routines. The default implementations are also implemented in dsPrintImpl.c file.

dsPrintImpl.c: The C file containing default print messages for all the records. The applications can also provide implementation of the routines.

rmDsStruc.h: The structure used by application to read and write to the files.

Referring to Table 1 there is shown exemplary code (found in the MIB file) written using the IETF SMIv2 format as a data definition language. The example related to the definition of the temperature sensor.

TABLE 1
tempSensorTable OBJECT-TYPE

| | |
|---|---|
| SYNTAX | SEQUENCE OF TempSensorEntry |

MAX-ACCESS not-accessible

| | |
|---|---|
| STATUS | current |

DESCRIPTION

“ System card info table ”

::= { systemCard 3 }
tempSensorEntry OBJECT-TYPE

| | |
|---|---|
| SYNTAX | TempSensorEntry |

MAX-ACCESS not-accessible

| | |
|---|---|
| STATUS | current |

DESCRIPTION

“An entry (conceptual row) in the tempSensorTable.”

| | |
|---|---|
| INDEX | { lcIndex } |

::= { tempSensorTable 1 }
TempSensorEntry ::= SEQUENCE {

| | |
|---|---|
| tsNumber | Unsigned16, |

| | |
|---|---|
| tsThresholdLow | Unsigned16, |
| tsThresholdHigh | Unsigned16 |

}
tsNumber OBJECT-TYPE

| | |
|---|---|
| SYNTAX | Unsigned16 |
| MAX-ACCESS | read-only |
| STATUS | current |
| DESCRIPTION | “sensor number” |

::= { tempSensorEntry 1 }

tsThresholdLow OBJECT-TYPE

| | |
|---|---|
| SYNTAX | Unsigned16 |
| MAX-ACCESS | read-write |
| STATUS | current |
| DESCRIPTION | “Low threshold in degrees Celsius” |

::= { tempSensorEntry 2 }

tsThresholdHigh OBJECT-TYPE

| | |
|---|---|
| SYNTAX | Unsigned16 |
| MAX-ACCESS | read-write |
| STATUS | current |
| DESCRIPTION | “High threshold in degrees Celsius” |

::= { tempSensorEntry 3 }

tempSensorTableMaxRows OBJECT-TYPE

| | |
|---|---|
| SYNTAX | INTEGER(4) |
| MAX-ACCESS | read-only |
| STATUS | current |
| DESCRIPTION | “max rows” |

::= { systemCard 4}
.
.
.

```
tempSensorGroup OBJECT-GROUP
  OBJECTS { tempSensorTableMaxRows }
  STATUS current
  DESCRIPTION
```

“The system group defines objects which are common to all

managed systems.”

::= { resMgr 17}

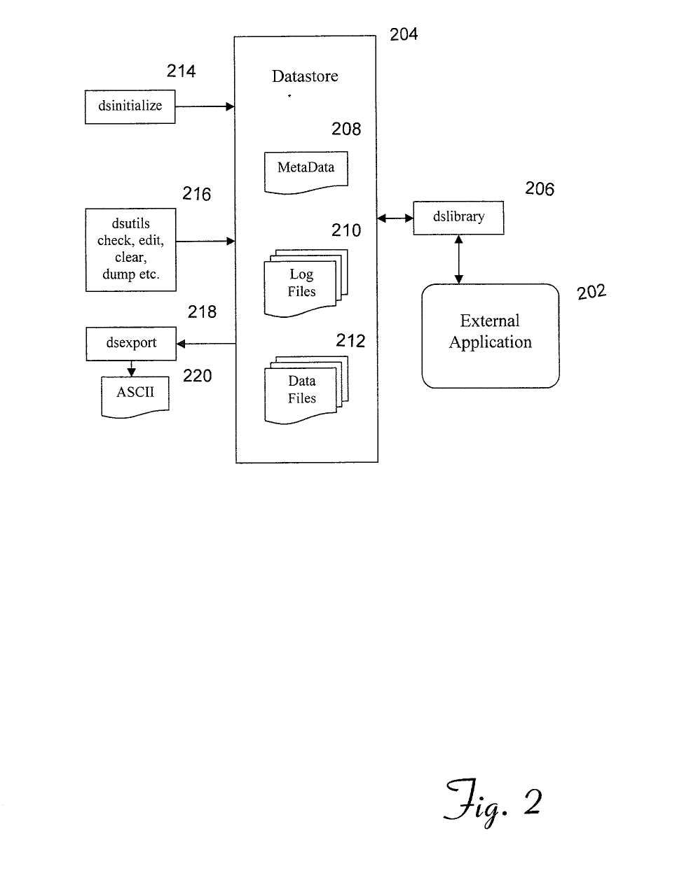

Referring to FIG. 2, there is shown a block diagram which depicts the interaction between a representative external application 202 and the datastore module 204. The external application 202 uses the datastore module 204 by calling the library functions provided by the “dslibrary” 206. Datastore 204 contains the MetaData 208, log files 210 and data files 212. Commands for accessing datastore 204 include dsinitialize 214, dsutils (check, edit, clear, dump, etc.) 216 and dsexport 218. Dsexport 218 provides the necessary interface to produce an ASCII file 220. Referring to Table 2 there is shown sample pseudo code for accessing persistent information (data).

TABLE 2

int resMgrTaskMain( )
{

AX2000HOST_DS_REC hostEntry;
/* read the entry from the datastore */
if (ds_getRecord(AX2000HOST_ID, 0, &hostEntry) ==

ERROR)

{

/* check if the record is not initialized. Initialize the
* the record with default value.
*/

if (errno == DS_INIT_RECORD)
{

appTaskUpdateDefaultValue(&hostEntry);

ds_setRecord(AX2000HOST_ID, 0, &hostEntry);

}
}
else
{

/* take action based on the values */
appUpdatePrompt(hostEntry. ax2000hostName);

}

/* Application specific code */

/* change value and update the data store */
strncpy(hostEntry.ax2000hostName, “ASRBOX1”);
ds_setRecord(AX2000HOST_ID 0, &hostEntry);

}

Here a resource manager task that is responsible for keeping the host name, obtains the value stored in the persistent information using the command ds₁₃ getRecord. It uses the record identity defined in dsRecId.h file, a row number (0), and buffer where the value needs to be put. If the data has not been initialized then ds_getRecord returns an error, and the record is initialized with a default value. When an entry changes it is updated using ds_setRecord.

The present invention includes a method for exporting data in ASCII format (by using the dsreport command) and that the display mechanism takes care of bytes ordering by use of magic number. Each data file contains a 4-byte magic number whose hex representation is 0xafbeadde. When a datastore data file is read on little endian machine this magic number is read as 0xdeadbeaf. It indicates the endianess has changed an all the subsequent displays are made by converting big endian to little endian.

In view of the foregoing description, numerous modifications and alternative embodiments of the invention will be apparent to those skilled in the art. It should be clearly understood that the particular exemplary computer code can be implemented in a variety of ways in a variety of languages, which are equally well suited for a variety of hardware platforms. Accordingly, this description is to be construed as illustrative only and is for the purpose of teaching those skilled in the art the best mode of carrying out the invention. Details of the structure may be varied substantially without departing from the spirit of the invention, and the exclusive use of all modifications, which come within the scope of the appended claim, is reserved.

We claim:

1. A method for providing persistency fault tolerant data stored in a database on a device in a networked environment for an external application, the device having an active processor system and a standby processor system, the method comprising the following steps:
providing an identical standby copy of an active database located on the active processor system, on the standby processor system;
monitoring the active processor for a failure;
assuming control by the standby processor system assumes control when the failure is detected;
wherein switching from the active database to the standby database is transparent to the external application.

2. The method as recited in claim 1 further comprising the step of keeping a compressed backup copy of the database with signature on the active processor system and on the standby processor system.

3. The method as recited in claim 2 further comprising the step of recovering data from the compressed backup copy when a failure event occurs.

4. The method as recited in claim 2 further comprising the step of recovering data from the compressed backup copy when a corruption event occurs.

5. The method as recited in claim 1 further comprising the step of defining the database using a predetermined format.

6. The method as recited in claim 5 further comprising the step of generating structure and metadata corresponding to the database using the definition in the predetermined format.

7. The method as recited in claim 1 further comprising the step of accessing the active database through an application program interface.

8. The method as recited in claim 5 wherein the predetermined format is Structure of Management Information version 2 (SMIv2) format.

9. A system for providing persistency fault tolerant data stored in a database on a device in a networked environment for an external application, the device having an active processor system and a standby processor system, the method comprising the following steps:
standby means for providing an identical standby copy of an active database located on the active processor system, on the standby processor system;
monitor means for monitoring the active processor for a failure;
control means for assuming control by the standby processor system assumes control when the failure is detected;
wherein switching from the active database to the standby database is transparent to an external application.

10. The system as recited in claim 9 further comprising backup means for keeping a compressed backup copy of the database with signature on the active processor system and on the standby processor system.

11. The system as recited in claim 10 further means for recovering data from the compressed backup copy when a failure event occurs.

12. The system as recited in claim 10 further means for recovering data from the compressed backup copy when a corruption event occurs.

13. The system as recited in claim 9 further means for defining the database using a predetermined format.

14. The system as recited in claim 13 further comprising means for generating structure and metadata corresponding to the database using the definition in the predetermined format.

15. The system as recited in claim 9 further comprising means for accessing the active database through an application program interface.

16. The system as recited in claim 13 wherein the predetermined format is Structure of Management Information version 2 (SMIv2) format.
